(19) United States
(12) Patent Application Publication
(10) Pub. No.: US 2018/0232384 A1
(43) Pub. Date: Aug. 16, 2018

(54) METHODS AND APPARATUS FOR INFORMATION CAPTURE AND PRESENTATION

(71) Applicant: ESKI Inc., Montreal (CA)

(72) Inventors: Vincent Leclerc, Montreal (CA); Vadim Kravtchenko, Montreal (CA); Justin Alexandre Francis, Montral (CA); Jean-Sébastien Rousseau, Montreal (CA)

(73) Assignee: ESKI Inc., Montreal (CA)

(21) Appl. No.: 15/953,819

(22) Filed: Apr. 16, 2018

Related U.S. Application Data
(63) Continuation of application No. 15/376,246, filed on Dec. 12, 2016.
Application No. 15/376,246 is a continuation of application No. PCT/CA2016/050688, filed on Jun. 15, 2016.
(60) Provisional application No. 62/219,310, filed on Sep. 16, 2015.

(51) Int. Cl. G06F 17/30

(52) U.S. Cl. CPC G06F 17/3087; G06F 17/30884; G06F 17/30867; G06F 17/30554

(57) ABSTRACT

Embodiments of the invention are directed to capturing, recording and sharing information relating to a user's important or memorable experiences. The capture of information relating to an experience may be initiated automatically, manually and/or using some combination of automatic and manual techniques, and the information may comprise video, audio and/or photos of the user and/or the experience, metadata describing aspects of the experience, information accessible via the World Wide Web, an indication of friends and associates in proximity to the user during the experience, and/or any other suitable information. Information relating to one user's experiences may be made accessible to other users, so as to create shared experiences and deepen social connections between users. Users may thus “bookmark” important or memorable life experiences, keep a record of information relating to those experiences, and share that information with others.

### RELATED APPLICATIONS

This application is a continuation of co-pending, commonly assigned U.S. patent application Ser. No. 15/376,246, filed Dec. 12, 2016, entitled “Methods And Apparatus For Information Capture And Presentation,” assigned Attorney Docket No. E0499.70003US01, which is a continuation of International Application No. PCT/CA2016/050688, filed Jun. 15, 2016, entitled “Methods And Apparatus For Information Capture And Presentation,” assigned Attorney Docket No. E0499.70003WO00, which claims priority to U.S. Provisional Application Ser. No. 62/219,310, filed Sep. 16, 2015, entitled “Methods And Apparatus For Information Capture And Presentation,” assigned Attorney Docket No. E0499.70003US00. The entirety of each of the documents listed above is incorporated herein by reference.

### BACKGROUND

Techniques for semi-automatic capture of content are known. For example, smartphone apps are available which enable users to capture high-quality images of subjects like documents by semi-automatically initiating capture of a photograph when a user orients the smartphone so that the subject is well-framed and focused within the smartphone's viewfinder. In addition, some wearable devices enable certain types of information to be automatically captured without direct user intervention. For example, some wearable devices may automatically capture information such as a wearer's heart rate, expenditure of calories, and other data.

### SUMMARY

Two commonly assigned U.S. Provisional Patent Applications entitled “Methods and Apparatus For Creating An Individualized Record Of An Event,” having Ser. Nos. 62/201,340 and 62/204,516, respectively and filed Aug. 5, 2015 and Aug. 13, 2015, respectively, each of which is incorporated herein by reference in its entirety, disclose techniques for capturing information to create a record of an event which is individualized to a particular attendee of the event. For example, in some embodiments which are disclosed in the '340 and '561 applications, during an event an attendee may transport a wearable device which is configured to periodically transmit a payload that includes an identifier (e.g., for the attendee and/or the wearable device). Transmissions by the wearable device may be received by one or more receiver components situated within the event venue. One or more content capture components positioned in the event venue (which may, for example, be associated with corresponding receiver components) may capture information (e.g., video, audio, metadata, etc.) relating to the event and/or the attendee as the event is ongoing. In some embodiments which are disclosed in the '340 and '561 applications, the location of each receiver component over time is known, and so receipt of transmissions from the wearable device at the different receiver components over time provides an indication of the attendee's location over the course of the event, and thus the vantage points from which the attendee experienced the event as it occurred. The attendee's location over time may be correlated with information captured by information capture components at different locations during corresponding time periods, to create a record of the event which is individualized for the attendee. This individualized record may then be made available to the attendee and others in any of numerous forms, such as via the World Wide Web.

Some embodiments of the present invention expand upon the techniques disclosed in the '340 and '561 applications to provide techniques which enable a user to record and “bookmark” information on memorable moments in his or her life, using any of numerous information capture components and/or devices. For example, some embodiments of the present invention may provide for information capture to be triggered automatically in response to one or more criteria being satisfied, in response to user input being received, and/or using a combination of automatic and manual techniques. Any suitable type(s) of information may be captured, such as video, audio and/or photos of the user and/or the experience, metadata describing various aspects of the experience, web pages then being read by the user and/or relating to the event, an indication of friends and associates in proximity to the user during the experience, and/or any other suitable information. Information may be captured by a device or component associated with (e.g., worn or operated by) the user, and/or by any other suitable device or component (e.g., a device or component worn or operated by an associate, a standalone device or component (e.g., a video camera or microphone configured for this purpose), a device or component designed to gain access to publicly available data (e.g., a crawler component with access to sites accessible on the World Wide Web), etc.).

In some embodiments of the invention, the user's location at the time information capture is initiated may be determined and recorded, using any of numerous techniques, and may be used to correlate captured information with the experience. Any information that is captured may be aggregated and made accessible (in any of numerous forms, such as via the World Wide Web) to the user, the users' friends and associates, and/or any other suitable individual(s). Further, information captured in relation to one user's experiences may be associated with corresponding information relating to other users' experiences, and made accessible to all associated users to create shared experiences and deepen social connections. As such, some embodiments of the invention may enable users to “bookmark” important life experiences, maintain a record of information relating to those experiences, and share that information with important people in their lives.

The foregoing is a non-limiting summary of only certain aspects of the invention. Some embodiments of the invention are described in further detail below.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 is a block diagram depicting components of a representative system for capturing information and correlating said information with experiences of individual users, in accordance with some embodiments of the invention;

FIG. 2 is a flowchart depicting a representative process whereby a component or device may initiate the capture of information, in accordance with some embodiments of the invention;

FIG. 3 is a flowchart depicting a representative process whereby captured information may be correlated with a particular event, user, location and/or time, in accordance with some embodiments of the invention;

FIG. 4 depicts a representative manner of displaying a body of information relating to experiences of one or more users, in accordance with some embodiments of the invention; and

FIG. 5 is a block diagram depicting a representative computer system which may be used to implement certain aspects of the invention.

### DESCRIPTION

Some embodiments of the invention are directed to techniques for enabling users to capture, record and share information relating to important or memorable experiences. In accordance with some embodiments of the invention, the capture of information relating to an experience may be initiated automatically (e.g., via execution of programmed instructions, such as in response to one or more predefined criteria being satisfied), manually (e.g., in response to user input), and/or using some combination of automatic and manual techniques. The information which is captured in relation to an experience may be of any suitable type(s). Examples include, but are not limited to, video, audio and/or photos of the user and/or the experience, metadata describing various aspects of the experience (e.g., biometric data indicative of a user's state of mind or emotional state, information describing environmental conditions such as sound levels, weather, etc.), information accessible via the World Wide Web which is then being created or read by the user and/or which relates to the event, an indication of friends and associates in proximity to the user during the experience, and/or any other suitable information. Information may be captured by any suitable device(s) or component(s), such as one which is associated with (e.g., worn or operated by) the user, associated with a friend of the user or other individual, a standalone device or component, etc. The user's location at the time of the experience may be determined, in any suitable fashion, and then recorded, and may be used to correlate captured information with the experience. Recorded information may be made accessible, to the user and/or others, in any of numerous forms, such as through an interface accessed via the World Wide Web. Information which relates to one user's experiences may be associated with corresponding information relating to other users' experiences, and made accessible to all associated users, so as to create shared experiences, and to deepen social connections between users. Users may thus “bookmark” important or memorable life experiences, maintain a record of information relating to those experiences, and share that information with others.

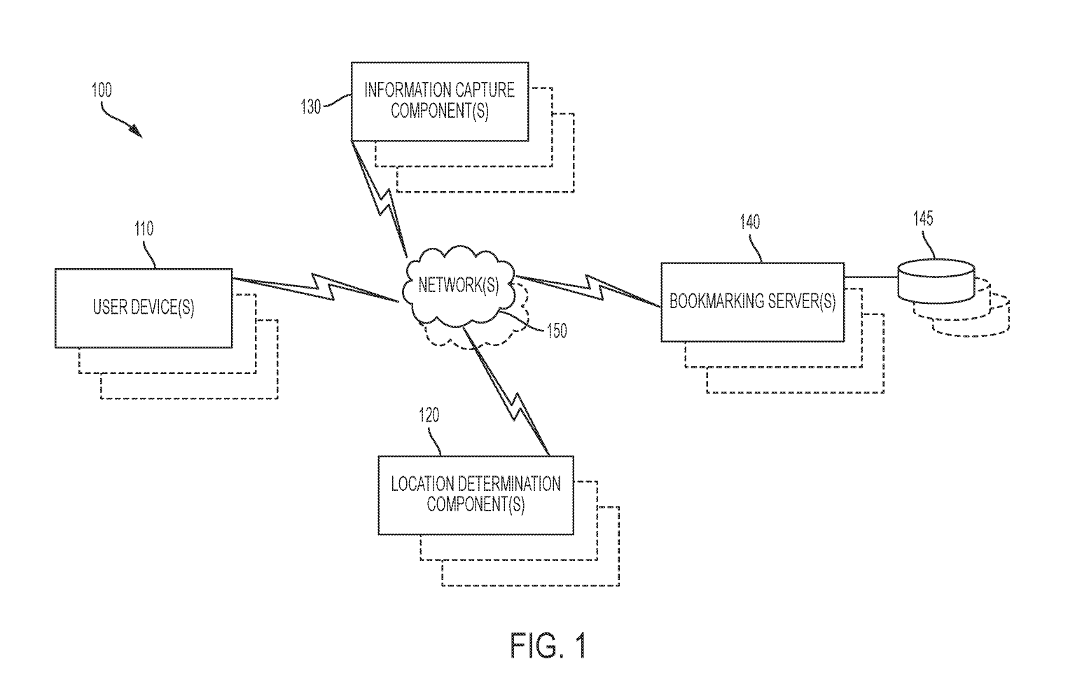

FIG. 1 depicts a representative system 100 for capturing and recording information relating to a user's experiences. Representative system 100 includes user device(s) 110, location determination component(s) 120, information capture component(s) 130, and bookmarking server(s) 140, any or all of which may communicate via network(s) 150.

Each user device 110 may comprise any device or component that a user may operate, wear, hold, carry or transport. For example, each user device 110 may comprise a mobile device such as a smartphone, tablet device, music player, gaming console, set-top box, in-dash console, wearable device (e.g., a wristband, hat, necklace, badge, medal, eyeglasses, ball, etc.), and/or any other suitable device or component. Although not shown in FIG. 1, each user device 110 may include a processor in communication with a memory which stores program instructions for execution by the processor, a user input component, transmitter and/or receiver. However, a user device 110 need not comprise such components. For example, a wearable user device 110 may comprise a radio frequency identification (RFID) tag (which may be a so-called “passive” or “active” tag), which may not include a separate processor and memory. Whether or not a user device 110 comprises such components, the user device 110 may be configured to capture any of numerous types of information relating to a user's experiences. For example, a user device 110 may be configured to capture sound, video, photos or other images, text (e.g. scheduling information supplied to the user device over a network, descriptions of experiences supplied by users, etc.), biometric information (e.g., on physical activity and/or physiological characteristics of a user), information on user input having been received to one or more devices, and/or any other type(s) of information.

Each location determination component 120 may comprise a device suitably configured for determining and/or recording the location of the user device(s) 110 over time. Any suitable technique(s) may be used to determine the location of a user device 110 at a particular time, and so any of numerous different types of location determination components may be employed. One representative technique which was described in the above-referenced '340 and '516 applications involves a location determination component at a known location receiving from a user device 110 a transmission payload which comprises an identifier. Because the location at which the payload is received is known, the location of the user device 110 at the time the transmission is received may be approximated. If more than one location determination component receives a transmission from a particular user device, then the signal strength of the transmission received by each location determination component may indicate which location determination component is nearest to the user device at the time the payload is received, to approximate the location of the user device 110 at that time.

As indicated in the '340 and '516 applications, a user device 110 may transmit a payload using any suitable communication technique(s) and/or protocol(s). For example, in some embodiments, transmission may be accomplished using radio frequency, infrared, and/or any other suitable transmission type(s). Further, a user device 110 may transmit information autonomously (e.g., according to a predetermined periodicity or schedule) and/or in response to one or more trigger events (e.g., a signal having been received from a location determination component 120, user input having been supplied to user device 110, and/or in response to any other suitable trigger event(s)).

Of course, it should be appreciated that a location determination component 120 need not determine the location of a user device 110 based upon its own (i.e., the location determination component's) location, or based upon the location of any other component when a transmission is received from a user device, as any suitable technique(s) may be used to determine the location of a user device 110 at a particular time. For example, the location of a user device at a particular time may be determined using global positioning system (GPS) techniques, triangulation or trilateration (e.g., using cell network towers), based upon connections between the user device and one or more networking components (e.g., routers, beacons, etc.), based upon the location of a device (e.g., a smartphone or other mobile device) with which the user device 110 is paired (e.g., determined using any one or more of the preceding techniques) or otherwise in communication, any combination of the preceding techniques, and/or any other suitable methods for determining the location of a user device 110.

Each information capture component 130 may be configured to capture information relating to user experiences. The information captured by each component 130 may be of any suitable type. For example, an information capture component 130 may be configured to capture sound, video, and/or images of the component's environment or setting, information indicative of the user's state of mind or emotional state, information which is accessible via the World Wide Web, and/or any other suitable type(s) of information.

In some embodiments of the invention, an information capture component 130 may be designed to offer functionality which is complementary to that which is provided by user device(s) 110, such as to enrich, augment or provide context to information captured by the user device(s) 110. For example, if the experience for which information is to be captured is a concert at which the user is an attendee, and a user device 110 operated by the user is a smartphone which captures video of the concert from the user's perspective, then an information capture component 130 may be a standalone video camera that captures video footage of the concert from a different vantage point, or which depicts the user dancing, singing and interacting with those around her at particular times during the concert. Any of numerous types of information capture components 130 may be employed, to capture any of numerous types of information, as the invention is not limited in this respect.

An information capture component 130 which is designed to capture information complementary to that which captured by a user device may, for example, be a standalone component (e.g., device), or integrated with one or more other components, and may be stationary, mobile or both (e.g., intermittently mobile when not fixed in a specific location). When stationary, a component 130 may be fixed in any suitable location, such as on a street corner, within an event venue (e.g., affixed to a stand, entry point, etc.), at a recreation space, etc. When mobile, a component 130 may be transported by a human (e.g., a photographer, entertainer, etc.) and/or mechanical components (e.g., mobile cart, transport apparatus suspended above a location, etc.).

Of course, an information capture component 130 need not be configured to capture content depicting or describing a physical setting. For example, an information capture component 130 may comprise a web crawler configured for retrieving content from one or more sites accessible via the World Wide Web. For example, if an experience for which information is to be captured is a chance meeting between the user and a celebrity, then a web crawler may retrieve information on the celebrity from one or more sites on the web, such as to complement or provide context to other information captured by the user with his/her device. Retrieved information may, for example, later be associated with information captured by the user's device, and/or one or more other components (e.g., using the techniques described below). Any suitable type(s) of information may be captured or retrieved, by any suitable component(s), as the invention is not limited in this respect.

Each bookmarking server 140 may comprise a device suitably configured to access an information repository 145 to store and retrieve information on user experiences captured by any one or more of the components described above. In some embodiments, bookmarking server 140 may correlate information received from user device(s) 110 and information capture component(s) 130 with information received from location determination component(s) 120, so as to associate the information relating to individual user experiences with a location and time.

This may be accomplished in any of numerous ways. In some embodiments, various items of information received from one or more user devices 110 associated with a particular user may each include a timestamp indicating a time at which the item was created, received and/or retrieved, and this time indication may be compared to an indication of the user's location at different times provided by location determination component(s) 120 to determine where the user was located at the times that each item was created, received and/or retrieved. This user/time/location indication may then be used to identify corresponding information captured by one or more information capture components 130.

As an example, video automatically captured by a user's smartphone of a goal during a soccer match may include a timestamp, and the timestamp may be matched to data describing the user's location over time to determine where in the stadium the user was sitting when the goal was scored. This information may then be used to identify corresponding information captured by various components describing events at the same location and time, such as video captured by another camera in the stadium (e.g., showing the goal from another vantage point, the reaction from other members of the crowd in the section of the stadium where the user was sitting, etc.), a sound recording captured by a microphone in the press box of an announcer's call of the goal, up-to-date statistics retrieved from the web relating to the game and/or players as a result of the goal, information describing the reaction of other fans watching the game from around the world, information on sound levels in the stadium before and after the goal was scored, and/or any other suitable information. Of course, it should be appreciated the invention is not limited to correlating information received from user device(s) 110 and information capture component(s) 130 with information received from location determination component(s) 120 in the manner described above, as any suitable technique(s) may be employed.

It should also be appreciated that a user's “location” at a particular time may be defined at any suitable level(s) of granularity. For example, information received from a particular user device 110 may be correlated with information received from an information capture component 130 (and/or with information received from another user device 110) based upon the information from both components relating to events occurring in the same venue (e.g., in the same soccer stadium, on the same street corner, at the same beach, at the same museum, etc.), in the same area of a city (e.g., in Harlem, at the same ski resort, on the strip in Las Vegas, etc.), in the same city, state, province, country, continent, hemisphere, etc. The invention is not limited to defining a user's “location” in any particular manner.

Further, it should be appreciated that although some embodiments of the invention described herein may correlate information received from different components based upon the information relating to events occurring at the same location, not all embodiments of the invention are limited to a location-based correlation of information. For example, information received from various components may be correlated based on any suitable characteristic(s), such as based upon the information relating to the same or similar events, events occurring in similar settings, in similar environmental conditions, during similar activities, etc. For example, information received from a particular user device 110 may be correlated with information received from another user device 110 based upon the information from both devices relating to the same event (e.g., while each user experiences the event from a different physical location), relating to events occurring in the water (e.g., while each user swims in a different ocean), while it is snowing outside (e.g., as users in different parts of the world both build snowmen), in the kitchen (e.g., while users in different locations each cook a particular dish), etc. Any suitable event characteristic(s) may be used to associate information received from one component with information received from another component, as the invention is not limited to using only location information for this purpose.

In representative system 100, user device(s) 110, location determination component(s) 120, information capture component(s) 130 and bookmarking server(s) 140 communicate via network(s) 150, which may be comprise any suitable communications infrastructure, and enable communication using any suitable communication protocol(s) and/or technique(s). For example, one or more networks 150 may enable wireless and/or wired communication, and may include any suitable components, arranged in any suitable topology.

Additionally, any one or more of user device(s) 110, location determination component(s) 120, information capture component(s) 130 and bookmarking server(s) 140 may communicate substantially continually via network(s) 150, or intermittently. For example, an information capture component 130 may not be continually connected to network(s) 150, but rather may connect intermittently, such as after information (e.g., a certain amount of information, a certain type of information, etc.) is captured. Upon connecting, any information captured by the information capture component 130 may be synchronized (e.g., using an indication of the time at which the content was captured) with information captured by other devices by a bookmarking server 140.

Some embodiments of the invention may provide for different approaches to capturing information relating to user experiences. For example, in accordance with one approach, the capture of information relating to an experience may be initiated in response to one or more “triggering criteria” being satisfied. In embodiments employing this approach, information capture may be initiated automatically (e.g., via execution of programmed instructions, such as in response to one or more predefined criteria being satisfied), manually (e.g., in response to user input), and/or using some combination of automatic and manual techniques.

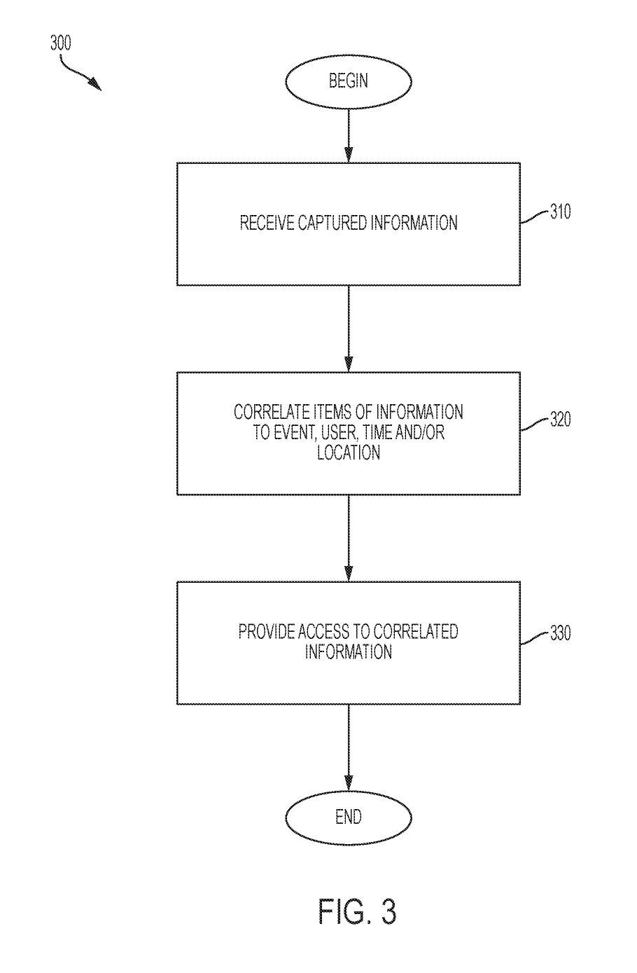

In accordance with another approach, some embodiments of the invention may provide for components to be capturing information on a substantially continual basis, rather than in response to such triggering criteria being satisfied, and then correlating the captured information with particular events, users, locations and/or times “after the fact” (e.g., using the techniques described below with reference to FIG. 3) One reason why correlating captured information with events, users, locations and/or times after the fact may be desirable is that the information which might otherwise be evaluated to determine whether triggering criteria are satisfied may not always be accessible. For example, if a standalone component is programmed to begin capturing content when certain biometric data is detected by a device worn by a user, but communication with the device has been interrupted at the time the biometric data is detected, then the standalone component may not begin capturing content until communication with the device is restored, which could be after a portion of the experience had already passed. Another reason why correlating captured information after the fact may be desirable is that it may be difficult or impossible in some circumstances to initiate information capture quickly enough after determining that triggering criteria are satisfied to capture all desired information relating to an experience. As one example, if information capture is to be initiated in response to certain data being detected by a device, some devices may not be capable of providing the data quickly enough after detection for all desired information relating to an experience to be captured. As another example, if information is to be captured on an experience if a user posts positive comments about the experience on social media, then initiating information capture only after such comments are posted could cause certain information about the experience (i.e., prior to the user's posts) to be omitted.

As such, some embodiments of the invention may provide for various devices and components to capture and store information substantially continuously, so that if a determination is made later that (for example) a user's biometric data, social media commentary, etc. at a particular time indicates that information on a related experience should be preserved, all of the desirable information relating to the experience may be maintained and retrieved for use.

Of course, it should be appreciated that the two approaches described above need not be employed on a mutually exclusive basis, as some embodiments of the invention may employ both approaches simultaneously (e.g., initiating information capture by some components in response to triggering criteria being satisfied, and providing for other components to capture information on a substantially continuous basis), use one approach in some circumstances and the other in other circumstances, or otherwise employ both approaches in various circumstances. It should also be appreciated that each individual system component may employ multiple approaches to capturing information. For example, a standalone video camera may record video content substantially continuously, but begin recording audio content only in response to certain triggering criteria being satisfied (or vice versa). Additionally, it should be appreciated that the invention is not limited to employing only the two approaches to information capture which are described above, as any suitable approach(es) may be employed, in any suitable way.

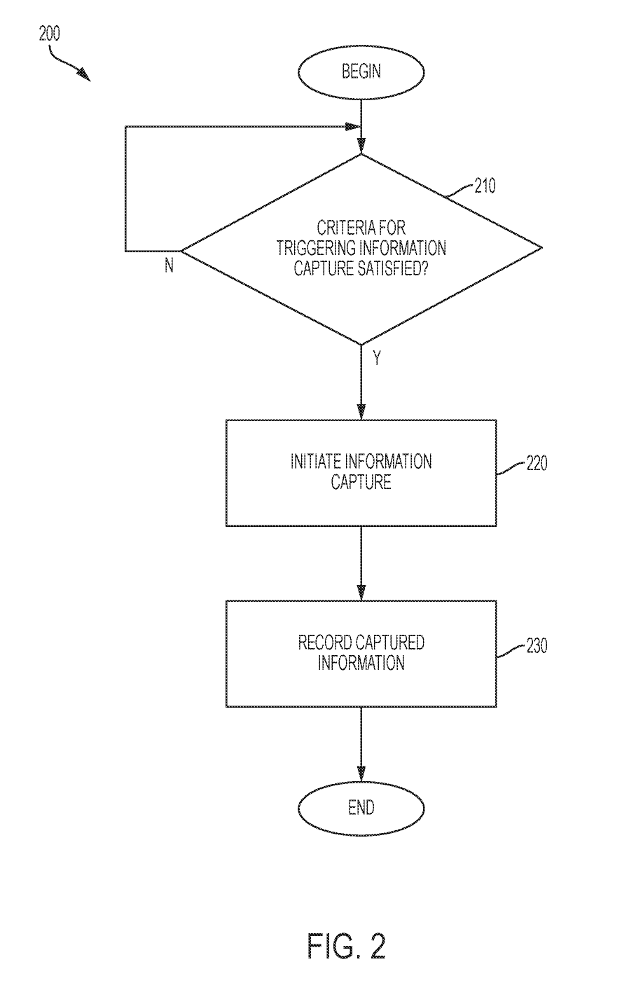

FIG. 2 depicts a representative process 200 which employs the approach described above whereby information capture is initiated upon a determination that one or more triggering criteria have been satisfied. At the start of representative process 200, a determination is made in act 210 whether one or more criteria for triggering information capture have been satisfied. Any of numerous criteria may be evaluated for this purpose, and so a determination whether such criteria have been satisfied may also be made in any of numerous ways. For example, a representative criterion for triggering information capture may be that user input has been received, such as via the press of a button, a touch to a screen, clapping of hands, snapping of fingers, blinking of eyes, a particular gesture, vibration, etc. Any suitable form(s) of user input may lead to a determination that information capture is to begin.

Some criteria may not involve receipt of affirmative input from a user. For example, in some embodiments, criteria for triggering information capture may include the detection of biometric information having certain characteristics (e.g., by a wearable device transported by a user). As one example, information indicating that a user's heart rate has reached a particular threshold rate (e.g., indicating that the user is excited) may trigger a determination that information capture is to begin, even in the absence of affirmative user input to that effect. As other examples, information indicating that a user's irises have expanded, that the user's voice has reached a particular volume and/or pitch, that the user has performed a particular gesture or movement, that the user is in motion and has reached a particular velocity or acceleration, etc., may trigger a determination that information capture is to begin. Of course, triggering information is not limited to information describing the user, as any of numerous other types of information may trigger a determination that information capture is to begin. Some examples include an indication that noise levels around the user have exceeded a particular threshold, that a threshold number of friends are in close proximity, that a particular individual is in close proximity, that environmental conditions have certain characteristics, that important news events are ongoing, etc. The detection or receipt of any suitable type(s) of information may contribute to a determination in the act 210 that information capture is to begin.

If it is determined in the act 210 that the criteria for triggering information capture have not been satisfied, then the act 210 is repeated. As such, representative process 200 proceeds to act 220 only when a determination is made that information capture is to begin.

In the act 220, information capture is initiated. This may be performed in any of numerous ways, by any of numerous different components, such as by user device(s) 110 and/or information capture component(s) 130 (FIG. 1). For example, a camera component may be instructed to start capturing video of a scene, a microphone component may be instructed to initiate capture of an audio recording, a heart rate sensor may be instructed to begin capturing a user's heart rate, a communication component may be instructed to determine whether friends or other individuals are in proximity, etc.

The act 220 may involve initiating information capture by any suitable number of components. For example, a camera component of a smartphone operated by a user and a standalone camera may both be instructed to initiate capture of video at the same time, such as to create different bodies of content describing a particular scene, which may later be synchronized. As another example, the camera components of different smartphones operated by different users may be instructed to begin capturing images at the same time, such as to capture a scene from multiple vantage points, such as to depict different members of a group sharing an experience. Any suitable number and type of components may initiate capture of content.

Representative process 200 then proceeds to act 230, wherein any information captured in the act 220 may be recorded. This, too, may be performed in any of numerous ways. In some embodiments, the device(s) which capture(s) content in the act 220 may communicate the information to a bookmarking server 140 for recordation in an information repository 145. Communication of information for storage may occur immediately upon the information being captured, or after a delay. Representative process 200 then completes.

FIG. 3 depicts a representative process 300 whereby information received from different components may be correlated, such as in relation to a particular event, user, location and/or time. In some embodiments of the invention, the correlation of different items of information may enable a user to access all of the information that is collected in relation to a particular experience, and/or enable multiple users to share information relating to an experience.

At the start of representative process 300, any information which has been captured in relation to an experience is received in the act 310. As indicated above in relation to FIG. 1, in some embodiments, items of information captured by one or more user devices 110, location determination components 120, and/or information capture components 130 may be received by one or more bookmarking servers 140, and so the act 310 may be performed by the bookmarking server(s). However, the invention is not limited to such an implementation, as any suitable component(s) may receive captured information, and/or perform any or all of the correlation steps described below.

Representative process 300 then proceeds to act 320, wherein items of information received in the act 310 are correlated to a particular event, user, time and/or location. This may be performed in any of numerous ways. In some embodiments of the invention, certain items of information received in the act 310 may be correlated with a particular user based at least in part on it having been captured by a device known to be associated with the user. For example, items of information received from a particular user device 110 which is known to be operated by a particular user may be automatically associated with that user.

Items of information may be correlated with a particular time, for example, based upon time information included in and/or received with the items. For example, in some embodiments of the invention, items of information captured by a user device 110 may include a timestamp indicating a time associated with the item. In some embodiments of the invention, an indicated time may reflect when an item was captured (e.g., by a user device 110 or information capture component 130), received (e.g., by a bookmarking server from a user device 110 or information capture component 130) and/or retrieved (e.g., by an information capture component 130 from a site on the web). However, it should be appreciated that a time indication may reflect any suitable time, as the invention is not limited in this respect.

An item of information may be correlated with a particular location in any of numerous different ways. As one example, an item may be correlated with a particular location based upon the item having been associated with a particular user and time, when the user's location at that time is known. For example, an indication that a particular item of content was created at a particular time by a device associated with a particular user may be cross-referenced with information indicating the location of the user's device at particular times (e.g., provided by location determination component(s) 120) to identify the location at which the item was created. As another example, an item of information may be correlated with a particular location based on data included with the information, such as longitude and/or latitude information or other information usable by a global positioning system to identify a location to be correlated with the item. As yet another example, an item of information may be correlated with a particular location based upon the item having been captured by a component at a known location. For example, an item captured by a component at a fixed location (e.g., a standalone mounted video camera) may be automatically correlated with that location.

An item of information may also be correlated with a particular event in any of numerous ways. For example, an item may be correlated with a particular location (e.g., using the techniques described above) which is known to be associated with the event (e.g., the event venue location, a location at which a group of people experienced the event from afar, etc.), or the item of information may identify the event (e.g., the item may be an item retrieved from the World Wide Web naming the event). Any of numerous techniques may be used to correlate an item of information with an event.

Of course, once items of information are correlated with particular events, users, locations and/or times, then they may be cross-referenced to enable information aggregation, access and sharing. For example, various items of information from disparate sources which are all correlated with a particular event may be aggregated so as to, for example, enable different users connected with the event (e.g., based on an expressed affinity for the event itself, a particular type of event, the performer(s) at the event, etc.) to access the information. Items of information which are correlated with a particular user may be aggregated so as to, for example, enable other users who have a connection with that user (e.g., “friends,” family members, etc.) to access the information. Items of information correlated with a particular location and time may be aggregated so as to, for example, allow users having a connection with the particular location (e.g., users who live at or nearby the location, who grew up near the location, etc.) and/or with the occurrences at the particular location at the particular time (e.g., users who were at the particular location at the particular time, other users who have a connection with those users, etc.) to access the information. Any of numerous modes of access based upon a correlation of information with particular events, users, locations and/or times may be envisioned, and the invention is not limited to any particular mode(s).

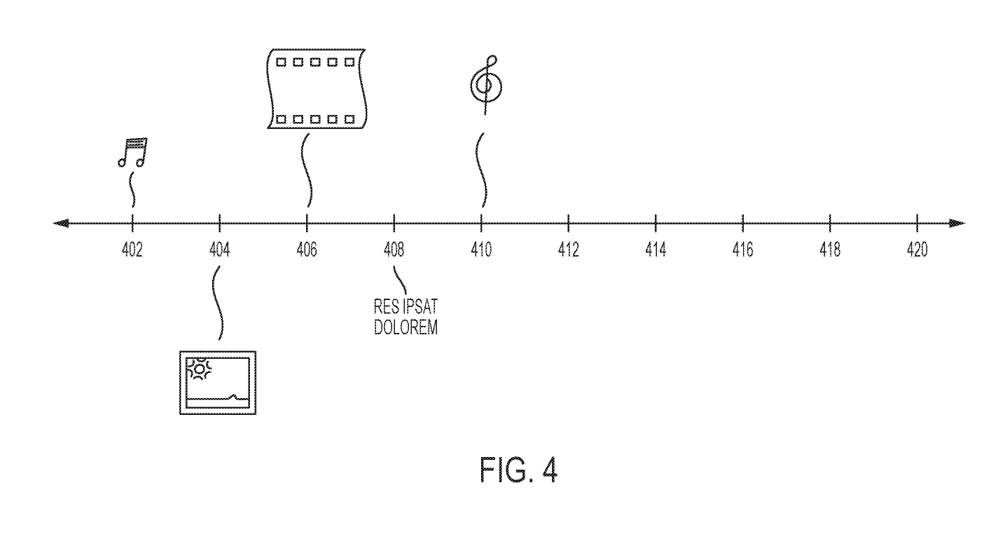

In act 330 of representative process 300, this access to information is provided. Access to information may be provided in any of numerous ways. In one representative technique described in the '340 and '561 applications, information may be presented on a “timeline” display, so that, for example, a user may view information associated with his/her location over time. FIG. 4 depicts a representative timeline depicting information associated with a user's location over a particular period of time. In the representative timeline shown, various markers relate to specific points in time, and information accessible via the markers relates to the user's location at those specific points in time. In this example, the user changed locations during the period of time represented by the timeline, so that marker 402 corresponds to one location 202 at a first time, marker 404 corresponds to another location 204 at a second (subsequent) time, marker 406 corresponds to location 206 at a third time, and so on. Of course, if the user did not change locations over the period of time represented by a timeline, then various markers may correspond to the same location, at different times.

Any suitable information may be associated with a particular point in time represented on a timeline. In the representative timeline shown in FIG. 4, a music file is associated with marker 404, an image is associated with marker 404, a video file is associated with marker 406, text information is associated with marker 408, and another music file is associated with marker 410. Of course, although not shown in FIG. 4, multiple types of information may be associated with particular points in time. For example, at a point in time when a user first saw her favorite band take the stage at a concert, there may be video content depicting the start of the concert, one or more images depicting the facial expressions of the user and those around her when this occurred, a text indication of which of her friends were around her when this occurred, a graph depicting the rise in noise level as the show started, and commentary on the start of the show from other users, gathered from various social media platforms. Information on an event which is made accessible via a timeline like that which is shown in FIG. 4 may include descriptors of sound levels indicating crowd enthusiasm at different times during the event, the number of attendees, information indicating the user's state of mind or emotional state, information describing a user's physical surroundings (e.g., weather conditions), and/or any other suitable type(s) of information.

The content which is made available to an attendee may be “raw” content (e.g., roughly as experienced by the attendee, or gathered from external sources) or it may be filtered, modified, augmented, segmented, remixed and/or otherwise modified to provide any desired user experience. Such modification may be performed automatically, manually or using some combination of automatic and manual techniques. For example, some embodiments may enable users to edit or modify information which is made available to him/her. For example, a user who doesn't like a photo of her which is shown on her timeline may delete the photo so that it is not shown to other users.

Of course, the invention is not limited to making information accessible via a timeline representation. Any suitable manner of display, presentation or other form(s) of access may be provided. As one example, information may be made available in map form, such as via a “heat map” indicating where a user was located most often during a particular time period (e.g., during a music festival at which multiple musical acts played at different stages throughout the event). In this mode of implementation, various items of information may, for example, each be associated with different locations on the map.

As another example, a “news feed” may display different items of information, which may be arranged in any suitable sequence. For example, items of information may be arranged chronologically, based on correspondence with various events experienced by a user, based on estimated importance to a user (determined in any suitable way), based on correspondence with a user's current location and/or a location with which the user has indicated some association, some combination of the foregoing, or in any other suitable way(s).

As yet another example, a multimedia montage may be generated from various types of information. Using the example given above of a user first seeing her favorite band in concert to illustrate, a montage may comprise a sequence including video of the start of the show, pictures of the user and her friends around her at various points during the show, a graphic showing different comments posted to social media at various times during the show, video of the user dancing to different songs, a graphic showing how social media activity picked up at various points during the show, video depicting lighting and other effects during the show, all of which may be set to audio captured during the concert. Any suitable type(s) of information may be represented in a montage.

Information may be made available to users via any suitable platform(s). For example, information may be made available via the World Wide Web, a physical display venue located onsite at an event, via an application executing on a computing device (e.g., a mobile “app”), and/or using any other suitable technique(s) and/or mechanism(s). Further, information need not be made available via bidirectional communication between user devices (e.g., user device(s) 110, FIG. 1) and other components (e.g., bookmarking server(s) 140, FIG. 1). For example, an app executing on a user's mobile device may display information which was previously retrieved from a database. Any suitable technique(s), employing any suitable mode(s) of communication, may be used for presenting information to a user.

In some embodiments, a user may designate certain information relating to his/her experiences as private, so that only certain other users may access the information, and/or so that the information may only be used in specified ways. For example, a user may designate video relating to a concert she attended (e.g., video which she recorded using her smartphone or other user device 110, video depicting her at the show which was recorded by an information capture component 130, etc.) as private, and specify that only certain people may view the video, that other users may not use the video on “their” timeline, etc. A user may restrict access and/or usage of information relating to his/her experience in any suitable way.

Further, in some embodiments of the invention, such restrictions may be event-, location- and/or time-based. Using the above example of the video relating to a concert attended by a user to illustrate, the user may specify that the video may only be accessed and/or used by other users who were in close proximity to her during the concert, by users who were nearby at specific times (e.g., when a certain act was onstage), etc.

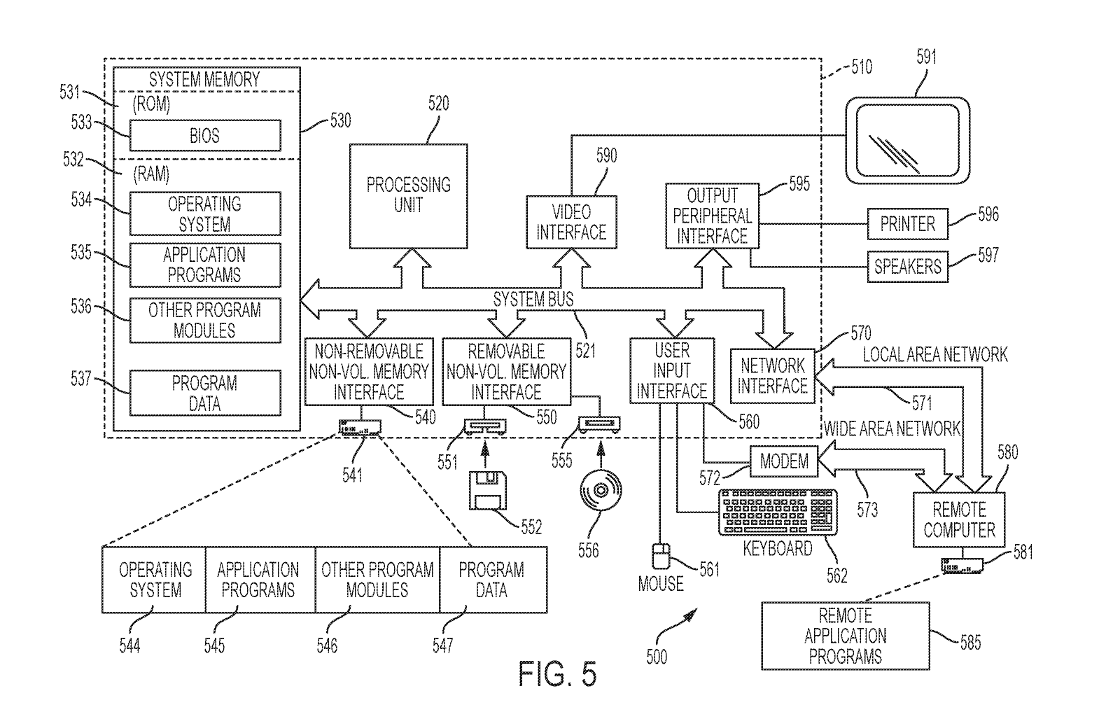

FIG. 5 illustrates one example of a suitable computing system 500 which may be used to implement certain aspects of the invention. The computing system 500 is only one example of a suitable computing system, and is not intended to suggest any limitation as to the scope of use or functionality of the invention. Neither should the computing system 500 be interpreted as having any dependency or requirement relating to any one or combination of components illustrated in the exemplary computing system 500. In this respect, embodiments of the invention are operational with numerous other general purpose or special purpose computing systems or configurations. Examples of well-known computing systems and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing systems that include any of the above systems or devices, and the like.

The computing system may execute computer-executable instructions, such as program modules. Generally, program modules include routines, programs, objects, components, data structures, etc. that perform particular tasks or implement particular abstract data types. The invention may also be practiced in distributed computing systems where tasks are performed by remote processing devices that are linked through a communications network. In a distributed computing system, program modules may be located in both local and remote computer storage media including memory storage devices.

FIG. 5 depicts a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 510. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 541 is typically connected to the system bus 521 through an non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through a output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which an example has been described. The acts performed as part of the method may be ordered in any suitable way. Accordingly, embodiments may be constructed in which acts are performed in an order different than illustrated, which may include different acts than those which are described, and/or which may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An apparatus, comprising:
at least one content capture device, suitable for deployment within an event venue at which an event takes place;
at least one computer-readable storage medium having instructions encoded thereon; and
at least one computer processor, programmed via the instructions to:
cause capture, on a substantially continuous basis, by the at least one content capture device, of content depicting or describing a physical location within the event venue;
in response to determining that an attendee at the event is having or has had a memorable experience at the physical location within the event venue, associate a portion of the captured content with the attendee, wherein determining that the attendee is having or has had a memorable experience comprises one or more of receiving an indication of affirmative input provided by the attendee to a user device associated with the attendee, analyzing biometric data for the attendee, analyzing data indicating an environmental condition around the user device, and analyzing commentary relating to the event on a social media platform;
make available to the attendee a collection of content relating to a plurality of experiences of the attendee over time, the collection of content comprising the portion of captured content that is associated with the attendee; and
enable the attendee to modify the collection of content that is made available to the attendee.

2. The apparatus of claim 1, wherein the at least one computer processor is programmed via the instructions to:
determine that the attendee is at the physical location at a point in time; and
associate the portion of the captured content with the attendee based at least in part upon the portion depicting or describing the physical location substantially at the point in time.

3. The apparatus of claim 2, wherein the at least one computer processor is programmed via the instructions to determine that the attendee is at the location at the point in time by processing information included in a transmission between a user device transported by the attendee and a location determination component within the event venue.

4. The apparatus of claim 1, wherein the portion of the captured content which the at least one computer processor is programmed via the instructions to associate with the attendee depicts or describes the attendee.

5. The apparatus of claim 1, wherein the portion of the captured content which the at least one computer processor is programmed via the instructions to associate with the attendee depicts or describes someone or something other than the attendee.

6. The apparatus of claim 1, wherein the at least one computer processor is programmed via the instructions to determine that the attendee is having or has had a memorable experience by analyzing biometric information for the attendee, the biometric information comprising data relating to physical activity and/or physiological characteristics of the attendee.

7. The apparatus of claim 1, wherein the at least one computer processor is programmed via the instructions to determine that the attendee is having or has had a memorable experience by analyzing biometric information for the attendee, the biometric information comprising data indicating a state of mind or emotional state of the attendee.

8. The apparatus of claim 1, wherein the collection of content which the at least one computer processor is programmed via the instructions to make available to the attendee comprises an item of information relating to the event.

9. The apparatus of claim 1, wherein the collection of content which the at least one computer processor is programmed via the instructions to make available to the attendee comprises information retrieved from the World Wide Web.

10. The apparatus of claim 9, wherein the information retrieved from the World Wide Web relates to at least one of the event, an attraction at the event, and a person at the event.

11. The apparatus of claim 1, wherein the collection of content which the at least one computer processor is programmed via the instructions to make available to the attendee comprises information captured by a device transported by the attendee at the event.

12. The apparatus of claim 1, wherein the collection of content which the at least one computer processor is programmed via the instructions to make available to the attendee comprises information from a device transported by another attendee at the event.

13. The apparatus of claim 12, wherein the information is captured by the device transported by the other attendee at the event.

14. The apparatus of claim 1, wherein the at least one computer processor is programmed via the instructions to make available the collection of content to the attendee via at least one of a timeline, a news feed and a heat map.

15. The apparatus of claim 1, wherein the at least one computer processor is programmed via the instructions to make available to the attendee a montage of media depicting or describing the event, the media comprising at least one of video, a photograph, and a graphic.

16. The apparatus of claim 15, wherein at least a portion of the montage is personalized to the attendee.

17. The apparatus of claim 1, wherein the collection of content which the at least one computer processor is programmed via the instructions to make available to the attendee comprises media of multiple types.

18. The apparatus of claim 1, wherein the at least one computer processor is programmed via the instructions to enable the attendee to modify the collection of content by modifying a privacy setting for an item in the collection of content.

19. The apparatus of claim 1, wherein the at least one computer processor is programmed via the instructions to cause capture of at least one of: media describing or depicting the physical location, information on one or more people at or near the physical location, information on an environmental condition at or near the physical location, and information relating to the event on one or more social media platforms.

20. The apparatus of claim 19, wherein the content that is cause to be captured comprises an indication of an environmental condition at or near the physical location, and wherein the environmental condition relates to a sound level or a level of enthusiasm.
